(19) United States
(12) Patent Application Publication
(10) Pub. No.: US 2009/0181262 A1
(43) Pub. Date: Jul. 16, 2009

(54) Coated Metal Product, Method to Produce It and Use of the Method

(76) Inventors: Ulrika Isaksson, Sandviken (SE); Magnus Cedergren, Sandviken (SE)

Correspondence Address: Carter, DeLuca, Farrell & Schmidt, 445 Broad Hollow Road, Suite 225, Melville, NY, 11747, US

(21) Appl. No.: 11/884,627

(22) PCT Filed: Feb. 17, 2006
(86) PCT No.: PCT/SE2006/000213

§ 371 Date: Feb. 19, 2009

(30) Foreign Application Priority Data
Feb. 17, 2005 (SE) 0500381-9

(51) Int. Cl. B32B 15/08; B05D 7/16; B05D 3/12

(52) U.S. Cl. 428/626; 427/409; 427/309

(57) ABSTRACT

A metal product having a metal substrate (2) and a coating thereon in the form of at least one functional and/or at least one decorative layer (8) has a layer (9) of a clear lacquer with a thickness of 10 nm to 10 μm on top of said at least one functional and/or at least one decorative layer.

### TECHNICAL FIELD OF THE INVENTION AND PRIOR ART

The present invention relates to a metal product having a metal substrate, i.e. metal in any shape or form, and a coating thereon in the form of at least one functional and/or at least one decorative layer.

The functional layer is a corrosion resistant layer or an electrically or thermally conductive layer for example and the decorative layer is a coloured layer for example. The invention also relates to an article comprising such a metal product and a method for manufacturing the metal product.

Metals are widely used in a variety of industrial and domestic applications. Functional and/or decorative coatings are sometimes applied to a metal to achieve a desired surface finish.

SE 0303596-1 discloses a coated stainless steel strip product comprising a decorative coloured layer on one or both sides of the strip. Although well functioning, this strip product exhibits for some applications insufficient resistance to wear. Since the colour of the layer is attained by interference the layer is very sensitive to fingerprints and is easily stained.

Generally a decorative or functional layer may deteriorate if the metal substrate is subjected to further processing steps such as deep drawing, punching, stamping, cleaning or heat treatment after the application of the decorative layer. If the metal substrate is cut or bent, in order to form the substrate into a finished product, cracks may be generated in the decorative layer causing it to flake off. The functionality, durability and aesthetic appearance of the finished article may therefore be adversely affected.

Problems associated with damaging a functional or decorative coating during the manufacture of an article may be avoided by applying the coating when the manufacturing process has been completed, however coating individual products is time-consuming and expensive.

### SUMMARY OF THE INVENTION

The object of the present invention is to provide a metal product of the above type having a high quality finish which is resistant to damage during its manufacture and use.

This object is fulfilled by at least partly coating said at least one functional layer and/or said at least one decorative layer with a layer of a clear, i.e. substantially transparent, lacquer with a thickness of 10 nm to 10 μm. The metal substrate comprises according to the embodiment of the invention at least one of the following metals; Ag, Al, Au, Co, Cu, Fe, Ni, Cr or an alloy based on any of these metals, such as a carbon steel or a stainless steel such as ferritic stainless steel, austenitic stainless steel, stainless spring steel, duplex stainless steel, hardenable chromium steel or precipitation hardenable stainless steel. In the case of a said metal substrate comprising Cr and/or Ni the product will be hard increasing the resistance to wear of the metal product. The clear lacquer protects the coated metal surface from stains, scratches and damage caused by impact and abrasion. The clear lacquer also increases the coated metal substrate's resistance to UV-radiation and consequently prevents cracking and discolouration of the lacquer and/or the functional/decorative layer. Since the layer of clear lacquer is so thin, it does not adversely affect the flexibility of the metal product. The coated substrate therefore has good formability and an enhanced aesthetic appearance.

According to an embodiment of the invention the thickness of the layer of the clear lacquer is up to 10 μm, advantageously up to 5 μm, preferably up to 2.5 μm, more preferably up to 1 μm and most preferably up to 500 nm. The more lacquer that is applied, the more the colour of any underlying decorative layer is changed and the more difficult it can be to process the coated metal. A clear lacquer layer up to preferably 5 μm thick allows the coated metal substrate to be processed further by forming methods to obtain an end article having the desired shape and properties without the lacquer cracking during the forming and without compromising the appearance or properties of the end article. Furthermore the thin layer of clear lacquer provides a sufficiently hard surface to make the metal scratch-proof and it makes the coating process more economical since such a small amount of lacquer is used.

According to an embodiment of the invention the clear lacquer comprises at least one of the following binding agents; polyester, acrylate, alkyd, polyvinyldifluoride and polyvinylfluoride. Binding agents in the form polyesters give a flexible product with UV-durability better than average. Acryl binding agents have the same properties as for the polyester but is considered to be more thermoplastic. Alkyd binding agents make the clear lacquer layer softer with less UV-durability, but the cost of the layer will be low. Polyvinyldifluoride and polyvinylfluoride as binding agents results in a better flexibility, hardness, UV-durability and chemically inertness of the clear lacquer layer than the other binding agents mentioned above, but they do also result in the most expensive clear lacquer layer. Thus, the choice of the binding agent is dependent upon the requirements put on the metal product in the later intended use thereof.

According to another embodiment of the invention the clear lacquer is water-based or solvent-based. Water-based lacquers are considerably less toxic than solvent-based lacquers so their use avoids numerous environmental and handling problems associated with solvent-based lacquers.

According to a further embodiment of the invention the clear lacquer contains a resin, such as amino resin in the form of a melamine and/or a carbamide, or a mixture of resins which are suitable for a transparent, semi-transparent or opaque top coat. Melamine influences the clear lacquer layer towards more flexibility, wherein carbamide makes the layer harder and more brittle.

According to a yet further embodiment of the invention the clear lacquer contains at least one of the following additives: a fingerprint-resistant additive, a levelling agent, antioxidants, a gloss-regulating additive, such as a gloss-dehancer or a gloss-enhancer, a UV-absorber to limit the risk of cracking or discolouration on exposure to weathering or an aesthetic additive, such as glitter or a pigment. The lacquer may be provided with a tactile component by applying the lacquer in a predetermined pattern or by varying the thickness of the layer of lacquer or by incorporating touch-detectable particles in the lacquer.

According to another embodiment of the invention the thickness of the metal substrate is between 0.015-3.0 mm.

According to a further embodiment of the invention the thickness of said at least one functional layer and/or said at least one decorative layer is max 10 μm, advantageously between 10 nm and 2 μm, preferably under 500 nm, more preferably under 250 nm and most preferred under 100 nm. According to a preferred embodiment of the invention the tolerance of the functional/decorative layer thickness is ±10%, preferably ±7%.

According to an embodiment of the invention said at least one functional layer and/or said at least one decorative layer comprises at least one of the following:
a binary metal oxide or a, ternary metal oxide or mixtures or solid solutions of said binary metal oxides, the main ingredient in such a mixture or solid solution being a metal oxide having the formula MeₓO_{y} such as Alₓ0_{y}, Tiₓ0_{y}, Wₓ0_{y}, Siₓ0_{y}, Zrₓ0_{y}, Coₓ0_{y}, or Crₓ0_{y} e.g. Ti0₂, Al₂0₃ and SiO₂.
a metal carbide or metal nitride such as TiN, TiAlN, ZrN, TiC, or CrN or a mixture thereof,
a metal such as Ag, Al, Au, Co, Cu, Fe, Mn, Si, Sn, Ti, V, W, Zn, Zr or an alloy thereof,
a carbonitride or an oxynitride.

A decorative layer may for example be produced in a two step process in which a first layer is applied and then processed, using a suitable heat- or chemical treatment for example, to give the layer a decorative surface finish.

According to another embodiment of the invention the functional and/or decorative layer has a multi-layer structure consisting of up to 10 layers having the same composition or different compositions so as to optimize function, colour spectra, reflectivity or consistency in colour for example. However, in the metal product according to the invention there are no other layers than such functional and/or decorative layers between the metal substrate and the clear lacquer layer, and it is the sum of these decorative and/or functional layers that has a thickness of max 10 μm, advantageously between 10 nm and 2 μm, preferably under 500 nm, more preferably under 250 nm and most preferred under 100 nm.

According to another embodiment of the invention the metal product comprises at least one said decorative layer comprising a thin ceramic layer, such as an oxide, which creates a colour of the metal product through interference of inciding light.

According to another embodiment of the invention the metal product comprises a said decorative layer of a transparent oxide, such as TiO₂, coated by a layer of a clear lacquer having polyester as binding agent, which results in a flexible metal product with a high UV-durability of the clear lacquer layer.

According to another embodiment of the invention the metal product comprises an additional layer of a metal carbide or a metal nitride or an additional layer of a metal or a metal alloy, onto which additional layer said decorative layer of a transparent oxide, such as TiO₂, is applied. A functional layer of a metal carbide or a metal nitride below the decorative layer increases the resistance to wear of the metal product, whereas the functional layer of a metal or a metal alloy, especially comprising Cr and/or Ni, is suitable in some applications as a consequence of the high reflectivity thereof.

According to another embodiment the metal product is in the form of a strip, foil, wire, fibre, bar or tube or any other geometrical form.

The present invention also concerns a method for manufacturing a coated metal product according to any of the embodiments disclosed above. The method comprises the steps of coating a metal substrate with at least one functional layer and/or at least one decorative layer and coating said at least one functional layer and/or said at least one decorative layer with a layer of a clear lacquer.

According to another embodiment of the invention the functional and/or decorative layer is produced using a Physical Vapour Deposition (PVD) technique, such as sputtering or electron beam evaporation. Such a process provides a very thin evenly distributed, continuous layer with excellent adhesion. Excellent adhesion is defined as allowing the metal substrate to be bent over at least 90°, preferably at least 180°, over a radius corresponding to the thickness of the metal substrate. Another advantage of the use of the PVD technique for applying said functional layer and/or decorative layer is that a high coating speed may be obtained resulting in a correspondingly favourable production of the metal product from the cost point of view.

According to another embodiment of the invention the metal substrate is pre-treated, preferably by etching, for instance in the form of ion assisted etching, prior to producing said at least one functional layer and/or said at least one decorative layer. A pre-treatment in the form of an etching followed by a coating by means of the PVD technique results in a possibility to efficiently produce the metal product according to the invention, and according to a further embodiment of the invention the metal product is manufactured in a continuous roll-to-roll process. Metal articles that are coated on one or more sides may therefore be mass-produced without the need of time-consuming and expensive manual operations. The inventive method may however also be applied to batch production or the manufacture of individual articles.

The present invention also concerns the use of a clear lacquer for coating an article comprising a metal substrate that is coated with at least one functional layer and/or at least one decorative layer. The invention is particularly but not exclusively suitable for manufacturing an article for use in any of the following applications: out-door, under-water, sports, household-appliances, cameras, mobile phones, personal effects such as watches, glasses, cosmetics, clothing or decorative items. The invention is basically suitable for manufacturing any item comprising, or consisting of stainless steel that has a functional or decorative finish on at least a part of its surface.

Further advantages as well as advantageous features of the invention appear from the following description and the other dependent claims.

### BRIEF DESCRIPTION OF THE DRAWINGS

FIG. 1 shows a method according to an embodiment of the invention, and

FIG. 2 shows an article according to an embodiment of the invention.

It should be noted that the figures are not drawn to scale and that the size of certain features has been exaggerated for the sake of clarity.

The following description and drawings are not intended to limit the present invention to the embodiments disclosed. The embodiments disclosed merely exemplify the principles of the present invention.

### DETAILED DESCRIPTION OF EMBODIMENTS OF THE INVENTION

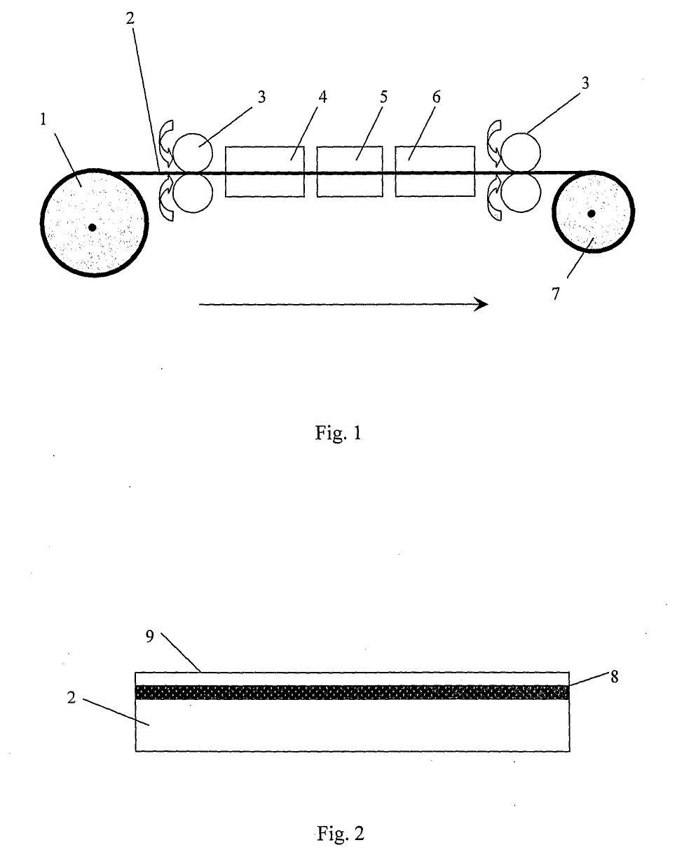

FIG. 1 shows a continuous roll-to-roll in-line process for manufacturing a coated stainless steel strip. A roll 1 of stainless steel strip is mounted for rotation about a horizontal axis. The strip 2 from the roll 1 is optionally fed through a pair of counter-rotating feed rollers 3. The strip 2 is passed through a pretreatment workstation 4 for cleaning for example, preferably by ion assisted etching.

The cleaned strip 2 is then provided with a functional layer or a decorative layer at workstation 5 in a single or multi-layer structure on one side of the strip 2. The workstation 5 may comprise one or more continuous PVD chambers for example, which allows a tolerance in layer thickness of about ±10% to be achieved and consequently a good consistency in colour. Both sides of the strip could of course be coated depending on the intended application(s). The strip 2 is then provided with a colourless lacquer, such as a polyester-based lacquer, at workstation 6 by spray coating or by any other means, such as by a roller, a roller coater, by dipping the strip into a bath or by any other method that results in the production of a thin, uniform lacquer layer. Any or all of the pre-treatment, coating or lacquering steps may be combined at a single workstation.

The lacquer is then cured i.e. hardened, set or dried. The lacquer may be cured at room temperature or by heating, by using radiation such as UV-radiation, by air drying, evaporating or by any other conventional method depending on the composition of the lacquer. The high-quality coated stainless steel strip is rolled up into a roll 7 as it is continuously formed. The coated stainless steel strip may then be formed into various articles, such as the outer shell of mobile phones for example.

The minimum feed rate of the roll-to-toll process is preferably 3 m/min, most preferred 25 m/min. Using such a method makes it possible to coat up to 20 km of stainless steel strip that is 3-5 dm wide at a time, which makes the method very simple and cost-efficient.

FIG. 2 shows a cross-section of the finished coated stainless steel article which comprises a stainless steel strip 2, coated with a functional or decorative layer 8 that is protected by a thin layer of scratch-proof and fingerprint-resistant clear lacquer 9. The clear lacquer used should be UV resistant, which means that it shall resist an exposure to sunlight of 400 h without being destroyed, such as being miscoloured or broken. It shall also be able to assume a temperature of 100° C. during 5 days without being miscoloured or otherwise destroyed.

The following examples describe tests that were preformed on a metal substrate according to embodiments of the invention.

### Example 1

A Sample 1 in the form of a 0.20 mm thick strip of a stainless steel coated with a layer of TiO₂ and thereafter with a layer of polyester-based lacquer was produced according to the method stated above. The substrate material had the following composition: 0.7% C, 0.4% Si, 0.7% Mn, max 0.025% P, max 0.010% S, 13% Cr. The thickness of TiO₂ was approximately 60 nm and the thickness of lacquer was approximately 100 nm.

A bending test was performed according to standard SS-EN ISO 7438 in order to test the adhesion of the coating to the substrate. The minimum bending radius was equal to the half of the thickness of the strip and the bending test was performed over 90°. Furthermore, the test was performed three times for each radius and both perpendicular and parallel to the coating direction. The results are shown in Table 1, where W means that the tested strip was whole and the coating showed no tendency of flaking or the like.

TABLE 1

| | Radius | | |
|---|---|---|---|
| Direction | 0.10 mm | 0.12 mm | 0.25 mm |
| Perpendicular | W | W | W |
| Parallel | W | W | W |

Furthermore, a bending test was performed according to standard B 489-85 in order to test the ductility of the coating to the substrate. The minimum bending radius was equal to the thickness of the strip and the bending test was performed over 180°. Furthermore, the test was performed three times for each radius and both perpendicular and parallel to the coating direction. The results are shown in Table 2, where W means that the tested strip was whole and the coating showed no tendency of flaking or the like and C means that the substrate showed cracks.

TABLE 2

| | Radius | | | |
|---|---|---|---|---|
| Direction | 0.20 mm | 0.40 mm | 0.70 mm | 1.25 mm |
| Perpendicular | W | W | W | W |
| Parallel | W | W | W | W |

### Example 2

A Sample 2 in the form of a 0.20 mm thick strip of a stainless steel coated with a layer of Al₂O₃ and thereafter with a layer of polyester-based lacquer was produced according to the method stated above. The substrate material had the following composition: 0.7% C, 0.4% Si, 0.7% Mn, max 0.025% P, max 0.010% S, 13% Cr. The thickness of Al₂O₃ was approximately 120 nm and the thickness of lacquer was approximately 500 nm.

A bending test was performed according to standard SS-EN ISO 7438 in order to test the adhesion of the coating to the substrate. The minimum bending radius was equal to the half of the thickness of the strip and the bending test was performed over 90°. Furthermore, the test was performed three times for each radius and both perpendicular and parallel to the coating direction. The results are shown in Table 3, where W means that the tested strip was whole and the coating showed no tendency of flaking or the like.

TABLE 3

| | Radius | | |
|---|---|---|---|
| Direction | 0.10 mm | 0.12 mm | 0.25 mm |
| Perpendicular | W | W | W |
| Parallel | W | W | W |

A bending test was performed according to standard B 489-85 in order to test the ductility of the coating to the substrate. The minimum bending radius was equal to the thickness of the strip and the bending test was performed over 180°. Furthermore, the test was performed three times for each radius and both perpendicular and parallel to the coating direction. The results are shown in Table 4, where W means that the tested strip was whole and the coating showed no tendency of flaking or the like.

TABLE 4

| | Radius | | | |
|---|---|---|---|---|
| Direction | 0.20 mm | 0.40 mm | 0.70 mm | 1.25 mm |
| Perpendicular | W | W | W | W |
| Parallel | W | W | W | W |

### Example 3

A Sample 3 in the form of a 0.20 mm thick strip of stainless steel coated with a layer of TiN and thereafter with a layer of polyester-based lacquer was produced according to the method stated above. The substrate material had the following composition: 0.7% C, 0.4% Si, 0.7% Mn, max 0.025% P, max 0.010% S, 13% Cr. The thickness of TiN was approximately 1 μm and the thickness of lacquer was approximately 15 um.

A bending test was performed according to standard SS-EN ISO 7438 in order to test the adhesion of the coating to the substrate. The minimum bending radius was equal to the half of the thickness of the strip and the bending test was performed over 90°. Furthermore, the test was performed three times for each radius and both perpendicular and parallel to the coating direction. The results are shown in Table 5, where C means that the coating cracked or showed cracks.

TABLE 5

| | Radius | | |
|---|---|---|---|
| Direction | 0.10 mm | 0.12 mm | 0.25 mm |
| Perpendicular | C | C | C |
| Parallel | C | C | C |

A bending test was performed according to standard B 489-85 in order to test the ductility of the coating to the substrate. The minimum bending radius was equal to the thickness of the strip and the bending test was performed over 180°. Furthermore, the test was performed three times for each radius and both perpendicular and parallel to the coating direction. The results are shown in Table 6, wherein C means that the coating cracked or showed cracks.

TABLE 6

| | Radius | | | |
|---|---|---|---|---|
| Direction | 0.20 mm | 0.40 mm | 0.70 mm | 1.25 mm |
| Perpendicular | C | C | C | C |
| Parallel | C | C | C | C |

In these tests both the lacquer and the TiN were broken due to the excellent adhesion of the lacquer to the TiN.

The invention is of course not in any way restricted to the embodiments thereof described above, but many possibilities to modifications thereof would be apparent to a man with ordinary skill in the art without departing from the basic idea of the invention as defined in the appended claims.

“Coated with a layer” does in this disclosure not mean that the entire surface or surfaces of the object in question is coated, but the object may be coated on only one of two or more sides or only on a restricted part of one or more such sides.

1. Metal product having a metal substrate (2) and a coating thereon in the form of at least one functional and/or at least one decorative layer (8), wherein said at least one functional layer and/or said at least one decorative layer (8) is/are at least partly coated with a layer (9) of a clear lacquer with a thickness of 10 nm to 10 μm.

2. Metal product according to claim 1, wherein the layer of the clear lacquer has a thickness of max 5 μm.

3. Metal product according to claim 1, wherein the thickness of the clear lacquer layer (9) is up to 2.5 μm, preferably up to 1 gm and more preferably up to 500 nm.

4. Metal product according to claim 1, wherein the clear lacquer (9) comprises at least one of the following binding agents; polyester, acrylate, alkyd, polyvinyldifluoride and polyvinylfluoride.

5. Metal product according to claim 1, wherein the clear lacquer (9) is water-based.

6. Metal product according to claim 1, wherein the clear lacquer (9) contains at least one resin, such as at least one amino resin in the form of a melamine and/or a carbamide.

7. Metal product according to claim 1, wherein the clear lacquer (9) contains at least one of the following additives: a fingerprint-resistant additive, a leveling agent, an antioxidant, a gloss-regulating additive, such as a gloss-dehancer or a gloss-enhancer, UV-absorber or an aesthetic or tactile additive.

8. Metal product according to claim 1, comprising at least one of the following metals; Ag, AI, Au, Co, Cu, Fe, Ni, Cr or an alloy based on any of these metals such as a carbon steel or a stainless steel such as ferritic stainless steel, austenitic stainless steel, stainless spring steel, duplex stainless steel, hardenable chromium steel or precipitation hardenable stainless steel.

9. Metal product according to claim 1, wherein the thickness of the metal substrate (2) is between 0.015 mm and 3.Omm and the thickness of said at least one functional layer and/or said at least one decorative layer (8) is max 10 μm, preferably between 10 nm and 2 μm.

10. Metal product according to claim 1, wherein said at least one functional layer and/or said at least one decorative layer (8) comprise(s) a binary metal oxide or a ternary metal oxide or mixtures or solid solutions of said binary metal oxides, the main ingredient in such a mixture or solid solution being a metal oxide having the formula MeₓO_{y}.

11. Metal product according to claim 1, wherein said at least one functional layer and/or said at least one decorative layer (8) comprise(s) a metal carbide or metal nitride such as TiN, TiAIN, ZrN, TiC, or CrN or a mixture thereof.

12. Metal product according to claim 1, wherein at least one functional layer and/or said at least one decorative layer (8) comprise(s) a metal such as Ag, AI, Au, Co, Cu, Fe, Mn, Si, Sn, Ti, V, W, Zn, Zr or an alloy thereof.

13. Metal product according to claim 1, comprising at least one said decorative layer (8) comprising a thin ceramic layer, such as an oxide layer.

14. Metal product according to claim 1, comprising a said decorative layer of a transparent oxide, such as TiO₂, coated by a layer (9) of a clear lacquer having polyester as binding agent.

15. Metal product according to claim 14, comprising an additional layer of a metal carbide or a metal nitride according to claim 11.

16. Metal product according to claim 1, wherein it is in the form of a strip, foil, wire, fiber, bar or tube or any other geometrical form.

17. Article characterized in that it comprises a coated metal substrate (2) according to claim 1.

18. Method for manufacturing a metal product according to claim 1 comprising the steps of coating a metal substrate (2) with at least one functional layer and/or at least one decorative layer (8), characterized in that it further comprises the step of coating said at least one functional layer and/or said at least one decorative layer (8) with a layer (9) of a clear lacquer.

19. Method according to claim 18, wherein said at least one functional layer and/or said at least one decorative layer (8) is produced using a Physical Vapour Deposition technique, such as sputtering or electron beam evaporation.

20. Method according to claim 18, wherein the metal substrate (2) is pre-treated, preferably by etching, prior to producing said at least one functional layer and/or said at least one decorative layer (8).

21. Method according to claim 20, wherein said pre-treatment of the metal substrate (2) comprises etching in the form of ion assisted etching.

22. Method according to claim 18, wherein the metal product is manufactured in a continuous roll-to-roll in-line process.

23. Use of a clear lacquer (9) for coating a metal substrate (2) that is coated with at least one functional layer and/or at least one decorative layer (8).

24. Use of a method according to claim 18 to manufacture an article for use in any of the following applications: out-door, under-water, sports, household-appliances, camera applications, mobile phones, personal effects such as watches, glasses, cosmetics, clothing or decorative items.

25. Metal product according to claim 14, comprising an additional layer of a metal or metal alloy according to claim 12, onto which additional layer said decorative layer (8) of a transparent oxide, such as TiO₂, is applied.
